(19) United States
(12) Patent Application Publication
(10) Pub. No.: US 2004/0154171 A1
(43) Pub. Date: Aug. 12, 2004

(54) Optically aligned center punch with integral double action striker

(76) Inventors: Katherine Utz, Austin, TX (US); Joel Samuel Utz, Austin, TX (US)

Correspondence Address: LAW OFFICE OF MICHAEL R. NICHOLS, 3001 S. HARDIN BLVD. STE. 110, PMB #155, MCKINNEY, TX, 75070, US

(21) Appl. No.: 10/633,089

(22) Filed: Aug. 1, 2003

Related U.S. Application Data
(60) Provisional application No. 60/400,760, filed on Aug. 1, 2002.

(51) Int. Cl. B25B 27/14

(52) U.S. Cl. 30/367

(57) ABSTRACT

An automatic optical center punch adapted to perform with high accuracy and ease of use is disclosed. The punch includes a spring-loaded hammer and a rotational latch mechanism. The rotational latch mechanism restrains the movement of the hammer to allow the spring to be compressed when pressure is initially applied to the punch by its operator. When the spring is fully compressed, the latch mechanism engages a cam surface, which causes the latch to rotate to release the hammer. The spring-loaded hammer makes contact with a punch head assembly, which causes perforation of the work surface to take place. Once the hammer has been extended by the spring, the latch engages a second cam surface, which causes the latch to rotate in the opposite direction to restrain the hammer in preparation for the next compression of the spring.

### CROSS-REFERENCE TO RELATED APPLICATION

This application claims the benefit of the filing date of corresponding U.S. Provisional Patent Application No. 60/400,760, entitled “OPTICALLY ALIGNED CENTER PUNCH WITH INTEGRAL DOUBLE ACTION STRIKER,” filed Aug. 2, 2002.

### BACKGROUND OF THE INVENTION

1. Technical Field

The present invention is related generally to machinists' tools. More specifically, the present invention is directed toward an optically-aligned center punch with an automatic striker mechanism.

2. Description of Related Art

Because standard, multi-flute twist drills are somewhat flexible and do not cut well at the end point, some means of starting a hole at a desired location is necessary to prevent the drill bit's drifting away from the intended placement. One method of starting holes is to place the point of a sharp object at the intended hole location and strike the object with a hammer to drive the point into the material leaving a small dimple at the intended hole location. A sharp object used for such a purpose is normally called a center punch.

Center punches of the style shown in FIG. 1 have existed for over one hundred years and are acceptable for low and medium precision work. The obtuse angle of the point limits the user's view of the point while aligning the punch to any desired location markings making accurate placement of the punch difficult. As shown in FIG. 1, the angle of the punch relative to the work surface, the angle of the hammer face relative to the punch, and the angle of the tangent to the arc followed by the hammer at its point of impact with the punch relative to both the punch and the work surface all affect the motion of the punch into the work surface and, therefore, the placement accuracy of the final punch mark.

The alignment fixture shown in FIG. 2 alleviates some of the problems of the basic center punch by holding the punch perpendicular to the work. An optical sighting device the same diameter as the punch can be used to place the fixture with a relatively high degree of accuracy, but since the hammer is still wielded manually, the accuracy of the final punch mark is often no better than that which can be achieved without the fixture.

Adding a narrow shaft to the basic center punch allows the use of an annular weight as a slide hammer for striking the punch as shown in FIG. 3. This arrangement ensures close alignment of the hammer's impact with the axis of the punch and, when used in conjunction with the alignment fixture of FIG. 2, can be used to place punch marks with a relatively high degree of positional accuracy, but only on horizontal surfaces. Devices which use smaller slide hammers driven by springs allow use on non-horizontal surfaces but require two hands to operate and are, therefore, difficult to use with an alignment fixture.

A more modern center punch with integral, double action striker is shown in FIGS. 4A-4C. This device (commonly called an “automatic center punch”) requires only one hand to operate because pressing the body of the punch toward the work first compresses a spring against the striker and then releases the striker to impact the punch. This device addresses the two handed operation problem of the spring operated slide hammer punch but at the expense of some loss of accuracy due to the clearances required by the rocking motion of its latch mechanism.

Thus, a need exists for a center punch that allows for convenience of use in a variety of environments and applications, while maintaining a high level of accuracy.

### SUMMARY OF THE INVENTION

The present invention is directed toward an automatic optical center punch adapted to perform with high accuracy and ease of use. The punch includes a spring-loaded hammer and a rotational latch mechanism. The rotational latch mechanism restrains the movement of the hammer to allow the spring to be compressed when pressure is initially applied to the punch by its operator. When the spring is fully compressed, the latch mechanism engages a cam surface, which causes the latch to rotate to release the hammer. The spring-loaded hammer makes contact with a punch head assembly, which causes perforation of the work surface to take place. Once the hammer has been extended by the spring, the latch engages a second cam surface, which causes the latch to rotate in the opposite direction to restrain the hammer in preparation for the next compression of the spring.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a prior art simple center punch;

FIG. 2 is a diagram of a prior art center punch with an alignment fixture;

FIGS. 3A-3B are diagrams of a prior art center punch with gravity operated slide hammer striker;

FIGS. 4A-4C are cross-sectional diagrams of a prior art center punch with integral, double action striker in the three critical positions during use;

FIG. 5 is a diagram of an alignment fixture in accordance with a preferred embodiment of the present invention;

FIG. 6 is a diagram of an optical alignment sight in accordance with a preferred embodiment of the present invention;

FIG. 6A is a diagram providing a close up of a spacer ring in FIG. 6;

FIG. 7 is a cross-sectional diagram of a center punch with integral, double action striker in accordance with a preferred embodiment of the present invention;

FIGS. 8-15 are diagrams of components of the punch shown in FIG. 7;

FIGS. 16, 16A, 17-18, 18A, and 19 depict four phases of the operation of a punch striking mechanism in accordance with a preferred embodiment of the present invention;

FIGS. 20-22 depict, from the perspective of the user, the operation of a center punch made in accordance with a preferred embodiment of the present invention; and

FIGS. 23-24 depict an alternative embodiment of the present invention employing an alignment fixture with a concave surface for engaging work surfaces of various shapes.

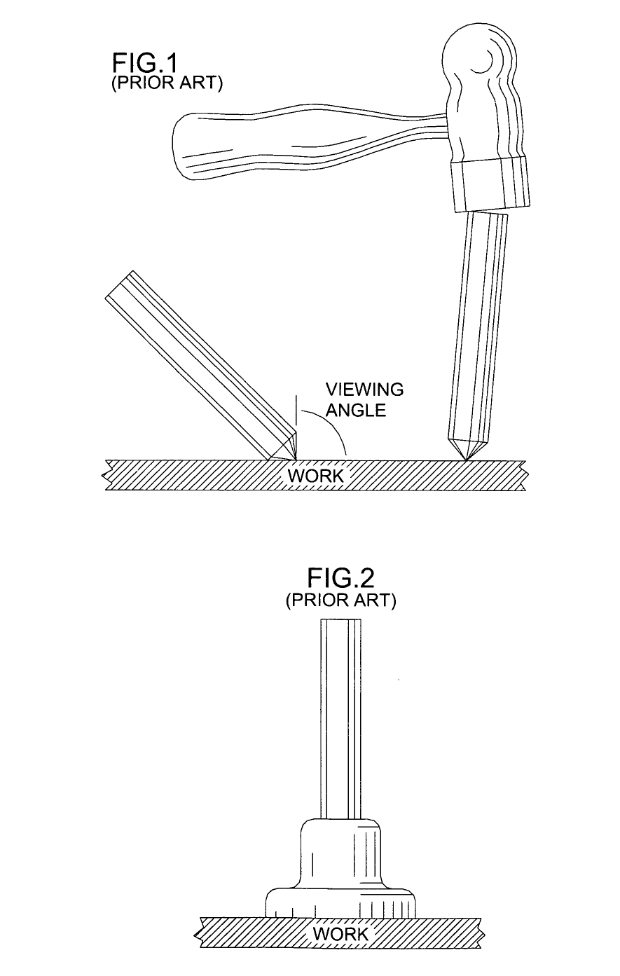

### DETAILED DESCRIPTION OF THE PREFERRED EMBODIMENT

The present invention is directed toward an automatic optical center punch with a double-action striker mechanism for high precision one-handed creation of holes or indentation in the surface of a work piece.

### USE

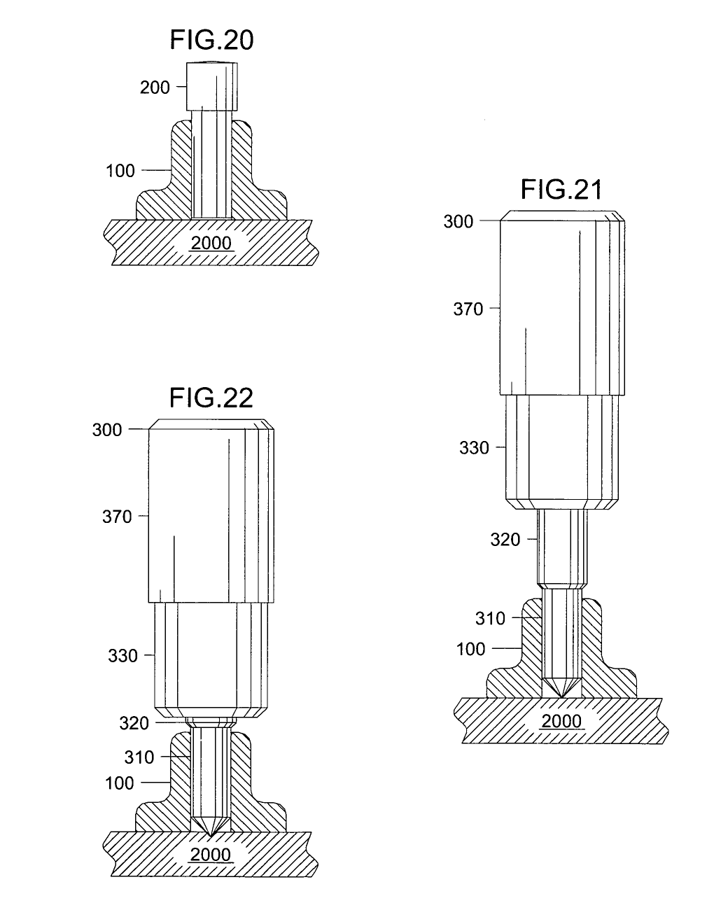

According to a preferred embodiment of the present invention, use of the optically aligned center punch is a two step process. As shown in FIG. 20, the first step is to place optical alignment sight 200 within the bore of the alignment fixture 100 and align alignment fixture 100 with the desired reference point on work piece 2000. Once alignment fixture 100 is properly positioned, it is held in place either manually or with clamps for the second step of the procedure.

During this process, a spacer ring 204 around reticle face 202 of the optical alignment sight 200 protects the reticle face from being scratched by small imperfections on the surface of the work piece while keeping the spacing between the reticle face consistent but small to minimize parallax errors during alignment.

Although the use of spacer ring 204 on optical alignment sight 200 increases the potential for parallax error when aligning alignment fixture 100 to the desired punch point, the narrow viewing range provided by the length of optical alignment sight 200 in relation to its diameter makes the maximum parallax error a fraction of the spacing between the reticle face 202 and the work piece. In practice, the view through such an optical alignment sight makes it easy to align the viewing angle to within a few degrees of vertical and make the parallax error insignificant.

The second step of the procedure is to remove the optical alignment sight 200 from the alignment fixture 100, place punch head 310 in the alignment fixture, and press end cap 370 of punch head 310 toward the work piece to actuate punch head 310's internal striker mechanism. This second step is shown progressively in FIGS. 21 and 22.

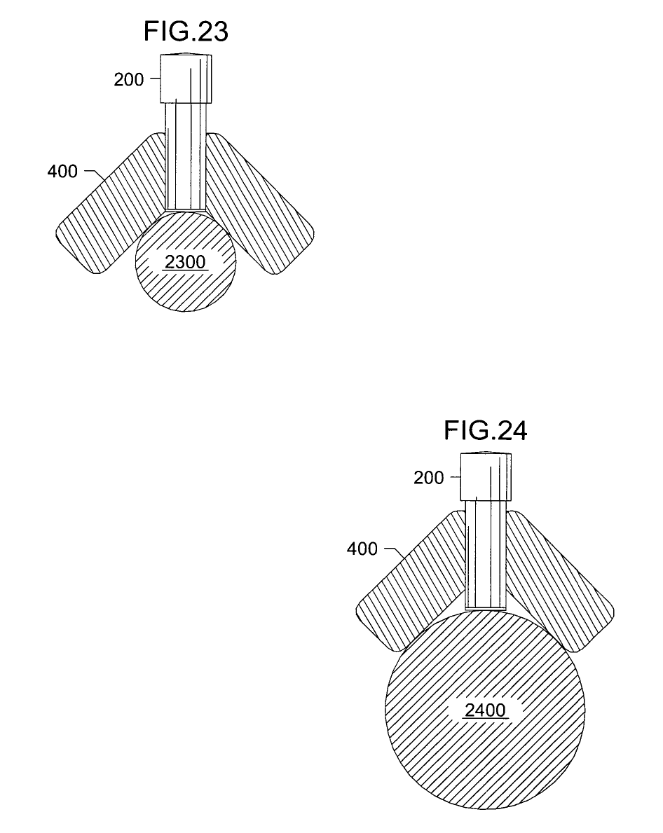

In an alternative embodiment of the present invention, depicted in FIGS. 23 and 24, a concave alignment fixture 400 is used in conjunction with optical alignment sight 200 to position concave alignment fixture 400 with respect to a location on a work surface that is not flat. In FIGS. 23 and 24, for example, cylindrical work surfaces 2300 and 2400 are shown. As shown in FIGS. 23 and 24, concave alignment fixture 400 allows placement on curved surfaces having a small radius of curvature relative to concave alignment fixture 400, such as spherical work surface 2300, or curved surfaces having a large radius of curvature relative to concave alignment fixture 400, such as work surface 2400. One of ordinary skill in the art will recognize that concave alignment fixture 400 may be used in conjunction with a wide variety of surfaces and that the application of concave alignment fixture 400 is by no means limited to spherical work surfaces. Moreover, one of ordinary skill in the art will recognize that any of a wide variety of alignment fixture shapes may be utilized in conjunction with an automatic center punch in accordance with the present invention without departing from the scope and spirit of the present invention.

### ALIGNMENT FIXTURE

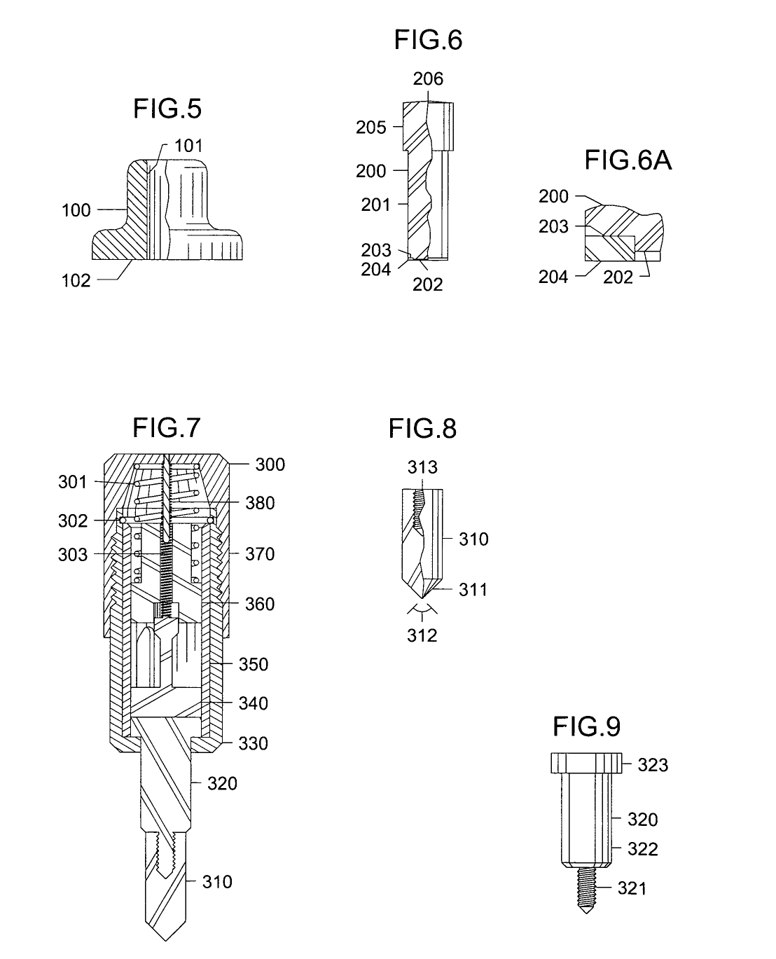

FIG. 5 shows a basic alignment fixture 100 for use on flat surfaces in conjunction with a center punch made in accordance with a preferred embodiment of the present invention. Alignment fixture 100 includes a bore 101 and work face 102. Bore 101 should be large enough to admit a useful amount of ambient light, accurately finished within very close tolerance of its nominal diameter and straight. Work face 102 should be smooth and oriented to hold bore 101 in the desired alignment with the work piece when the fixture is held firmly against the work piece. For the illustrated fixture 100, that means that the work face should be flat and perpendicular to the axis of the bore. Once these two critical features are ensured, the fixture should be shaped for easy manual manipulation and locating. Work face 102 may be covered or coated with an anti skid material to help hold it in place once it is properly located for use.

### OPTICAL ALIGNMENT SIGHT

FIG. 6 is a diagram of an optical alignment sight 200 in accordance with a preferred embodiment of the present invention. Optical alignment sight 200 is used to position the alignment fixture 100 relative to the desired hole location on the work piece. Optical alignment sight 200 is made of an optically transparent material and is placed within bore 101 of alignment fixture 100 prior to use. Shaft 201 of optical alignment sight 200 should be straight and long enough to extend all the way through bore 101 of the alignment fixture 100 and sized to provide a close, but easily sliding cylindrical fit within bore 101. Reticle face 202 of optical alignment sight 200 should be flat, perpendicular to the axis of shaft 201 and polished. Some form of visual alignment feature such as perpendicular lines intersecting at the alignment point (“cross hairs”) should be scribed, etched or drawn on the reticle face 202. A narrow, shallow recess 203 is formed around the periphery of reticle face 202 for the application of a thin spacer ring 204 which provides a small but definite space between reticle face 202 and the work piece. The relationship between the reticle face 202, spacer ring recess 203 and spacer ring 204 is shown more clearly in the enlargement of one edge of the reticle face end of the sight shown in FIG. 6A. The spacer ring 204 is preferably made of an abrasion resistant material and retained by an adhesive. Head 205 of optical alignment sight 200 has a non-critical diameter and should be long enough to protrude beyond the alignment fixture far enough for easy grasping for removal from the alignment fixture once the optical alignment is accomplished. Crown 206 of the sight is preferably radiused and polished to provide some degree of optical magnification of the reticle face and the work piece.

### CENTER PUNCH

A cross-section of a center punch 300 with integral, double action striker in accordance with a preferred embodiment of the present invention is shown in FIG. 7. The device consists of a punch head 310, an anvil 320, a latch 340, a latch spring 303, a latch spring guide 380, a cam sleeve 350, a cam sleeve retaining clip 302, a hammer 360, a hammer spring 301, a housing 330 and an end cap 370.

Hammer spring 301 is a compression spring which fits around hammer 360 and within the cam sleeve 350. Hammer spring 360's other parameters may be determined by normal spring design procedures to provide the striking energy desired.

Latch spring 303 fits around latch spring guide 380 and within bore 365 of hammer 360. Latch spring 303's other parameters may be determined by normal spring design procedures to provide enough force to hold latch 340, anvil 320, and punch head 310 fully extended when center punch 300 is turned upside down.

Cam sleeve retaining clip 302 is an expanding, split, circular ring familiar to those skilled in the art and sized to fit securely in groove 337 in housing 330.

### CENTER PUNCH PIECES

Punch head 310, which is shown in FIG. 8, may be made from standard punch materials using techniques known to those skilled in the art. The body of punch head 310 should be straight, long enough to extend all the way through bore 101 of alignment fixture 100 (FIG. 5) and sized to provide a close, but easily sliding cylindrical fit within bore 101 of alignment fixture 100. Point 311 of punch head 310 should be concentric with the body of punch head 310. The standard included angle (312) for center punches is 90° but other point designs could be made for special purposes. The end of punch head 310 opposite point 311 should be drilled and tapped 313 with a standard thread for attachment to anvil 320 (FIG. 9), but punch head 310 and anvil 320 could be made as a single unit to reduce cost at the expense of easily interchangeable punches.

Anvil 320, shown in FIG. 9, is essentially an extension of punch head 310 and can be made of similar material using similar techniques. Shaft 322 of anvil 320 should have a close, easily sliding cylindrical fit in opening 333 at the bottom of housing 330 (FIG. 13) while head 323 of anvil 320 should have a close, easily sliding cylindrical fit in cam sleeve 350 (FIG. 12). Point 321 of anvil 320 is threaded to fit punch head 310 if the two are not made in one piece.

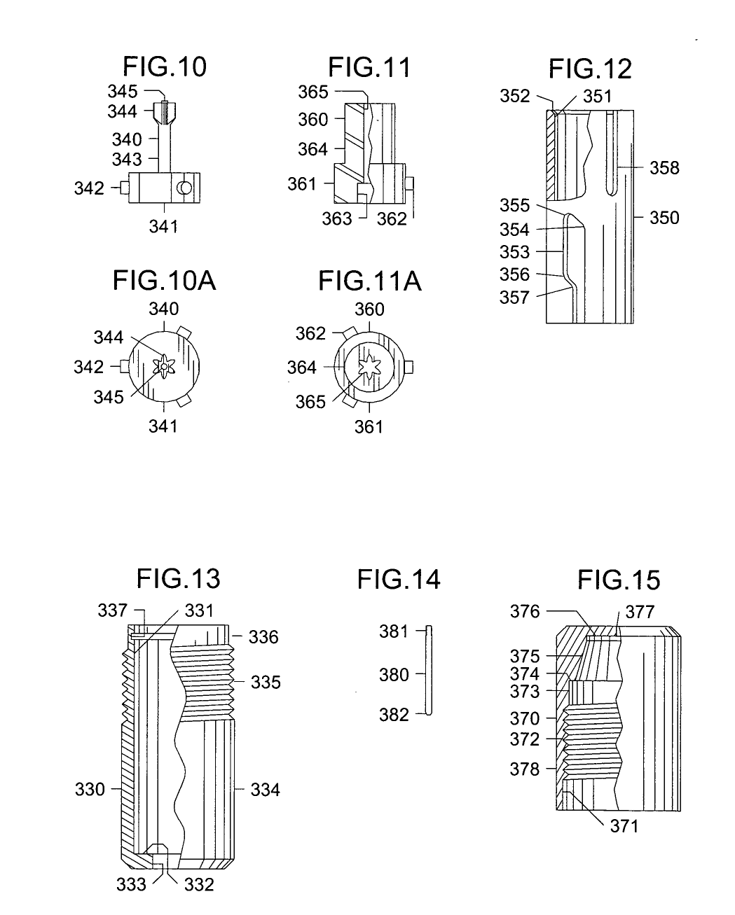

Latch 340, shown in side view in FIG. 10 and in top view in FIG. 10A, should be made of similar material to punch head 310 and anvil 320. Latch base 341 should have a close, easily sliding cylindrical fit in cam sleeve 350, but with cam pins 342 evenly spaced around the perimeter (three are shown, but the actual number is not critical) which extend into cam slots 353 in cam sleeve 350, but clear the inside of housing 330. Shaft 343 should have a clearance fit within the smallest diameter of bore 365 of hammer 360. Head 344 is splined for a close, easily sliding fit in splined bore 365 of hammer 360. Spring retention stub 345 should protrude from head 344 at least the diameter of the wire used for latch spring 303, but should have positive clearance from latch spring guide 380 when latch 340 is at the top of its stroke. Cam pins 342 and the tops of splines 344 should be hardened or coated with a hard substance and polished for easy sliding and long wear life.

Hammer 360 shown in side view in FIG. 11 and in top view in FIG. 11A should be made of similar material to punch head 310, anvil 320, and latch 340. Hammer base 361 should have a close, easily sliding cylindrical fit in cam sleeve 350, but with guide pins 362 evenly spaced around the perimeter (three shown but the actual number is not critical) which extend into guide slots 358 in cam sleeve 350 but clear the inside of housing 330. Hammer 360 has a bore 365 at the center down its length to clear latch shaft 343 and internally splined for a close, easily sliding fit with the splines on head 344 of latch 340. The base is counter-bored (363) from the bottom for a close, easily sliding cylindrical fit around the outer diameter of head 344 of latch 340 to allow the splines in hammer 360 to disengage the splines on the latch with head 344 of latch 340 still constrained within counter bore 363 of hammer 360. Hammer body 364 should fit within hammer spring 301 and be as long as possible while leaving positive clearance between it and end cap 370 when hammer 360 is at the top of its stroke. Guide pins 362 and the bottoms of splines 365 should be hardened or coated with a hard substance and polished for easy sliding and long wear life.

Cam sleeve 350 shown in FIG. 12 is a tube with guide slots 358 for hammer 360 at one end and cam slots 353 for the latch at the other end. Inside bore 351 of cam sleeve 350 should be accurately finished within a very close tolerance of its nominal diameter, straight and parallel to the outside of the sleeve. The hammer end of the sleeve should be chamfered 352 on the inside to prevent snagging of hammer spring 301 on the edge. Cam slots 353 rotate latch 340 at each end of its travel to align and unalign latch head splines 344 with hammer bore splines 365. The bottoms of cam slots 357 set the initial rotation of latch 340 to positively misalign latch head splines 344 from hammer bore splines 365. Upper ends 354 of the misalignment portions of the cam slots slope to upper travel limits 355 of cam slots 353, which are oriented to rotate latch head splines 344 into alignment with hammer bore splines 365. The bottoms of the alignment portions 356 of cam slots 353 slope back to the bottoms of the cam slots to rotate latch head splines 344 back out of alignment with hammer bore splines 365. Guide slots 358 are straight slots that prevent rotation of hammer 360 and limit its downward travel. The entirety of cam sleeve 350 should be hardened or coated with a hard substance and polished for easy sliding and long wear life.

Housing 330 shown in FIG. 13 has an inside bore 331 within which cam sleeve 350 should have a close, easily sliding cylindrical fit. Lip 332 at the bottom of the housing retains both cam sleeve 350 and anvil 320 but is bored 333 for protrusion of the shaft 322 of anvil 320 (FIG. 9). The outside of housing 334 is threaded 335 over part of its length for installation of end cap 370. Threads 335 should extend over a long enough area to allow some adjustment of hammer spring 301 force by partially unthreading end cap 370. Upper portion 336 of the outside of housing 330 should be relieved to slightly below the minor diameter of the threaded portion of housing 335 to provide clearance for the threads in end cap 372. Groove 337 for cam sleeve retaining ring 302 should be positioned to allow cam sleeve retaining ring 302 to solidly locate cam sleeve 350 against lip 332 at the bottom of the housing.

Latch spring guide 380 shown in FIG. 14 is, in a preferred embodiment, simply a cylindrical pin sized to fit inside the latch spring and including some provision 381 for attaching it to end cap 370. While the drawing shows screw threads for attachment provision 381, a simple press or shrink type interference fitting would work as well. Free end 382 of latch spring guide 380 should be chamfered or radiused to prevent snagging on latch spring 303.

End cap 370 shown in FIG. 15 has a section bored to clear threads 335 on housing 330 deep enough to cover housing threads 335 when end cap 370 is partially unscrewed for reduced hammer spring 301 tension. Adjacent to clearance bored section 371 is a section 372 threaded to match threaded section 335 of housing 330. Adjacent to threaded section 372 of end cap 370 is a short section 373 bored to clear relieved upper section 336 of the housing and produce a shoulder 374 which provides a positive stop for threading end cap 370 onto the housing 330. The profile of section 375 between shoulder 374 and hammer spring reaction surface 376 is not critical as long as it provides clearance for hammer spring 301 but the tapered section shown will ease assembly of the unit. The latch spring guide attachment provision 377 should match the attachment provision used on latch spring guide 381.

### PUNCH MECHANISM OPERATION

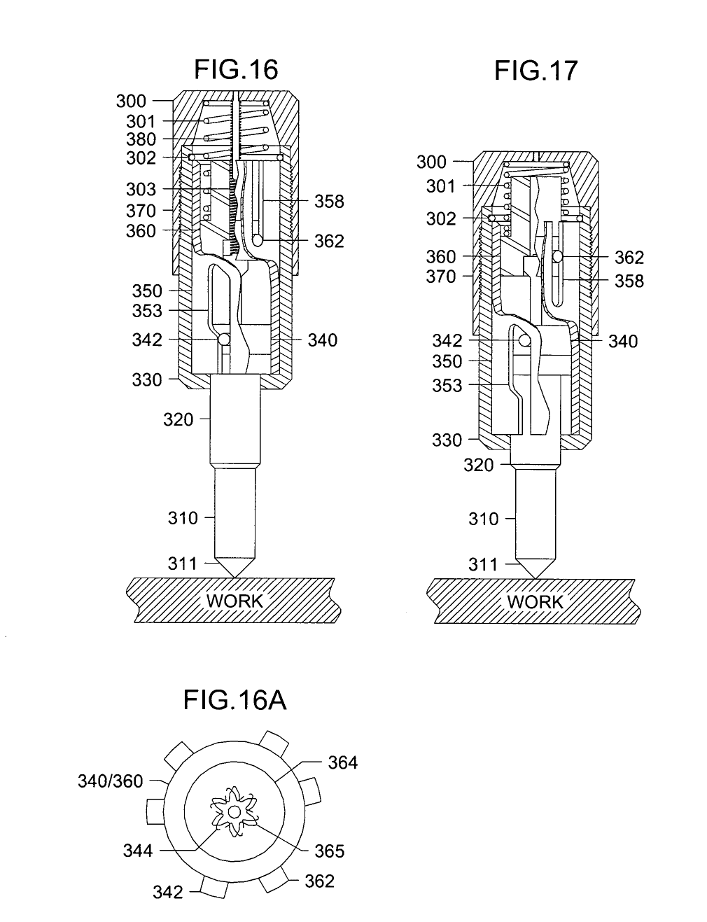

FIGS. 16-19 show center punch 300 with portions of cam sleeve 350, hammer 360, and latch 340 cut away in four different phases of the center punch 300's operating sequence. Latch spring 303 and latch spring guide 380, although shown in FIG. 7, are omitted from FIGS. 17-19 for clarity.

In FIG. 16, point 311 of center punch 300 is resting against the work with little or no pressure applied. Hammer spring 301 extends hammer 360 in the direction of point 311. Hammer 360 is restrained from moving towards point 311 by hammer guide pins 362, which are at the bottoms of guide slots 358. Latch spring 303 holds latch 340 at the bottom of its stroke against the anvil 320 and holds punch housing 330 and end cap 370 at their fully extended positions.

FIG. 16A is an enlarged top view of hammer 360 and latch 340, which shows their relative rotational positions in the phase of center punch 300's operation that is depicted in FIG. 16. The portions of the splines on latch head 344 depicted with dashed lines are hidden from view due to their misalignment from the splines in hammer bore 365.

As the user operates the punch by pressing punch housing 330 and end cap 370 toward the work piece, hammer spring 301 pushes hammer 360 toward latch 340 until the ends of the splines in hammer bore 365 meet the splines on latch head 344. From that point, further depression of the punch body compresses hammer spring 301 between hammer 360 and end cap 370 until the tops of cam slots 353 reach cam pins 342 on latch 340.

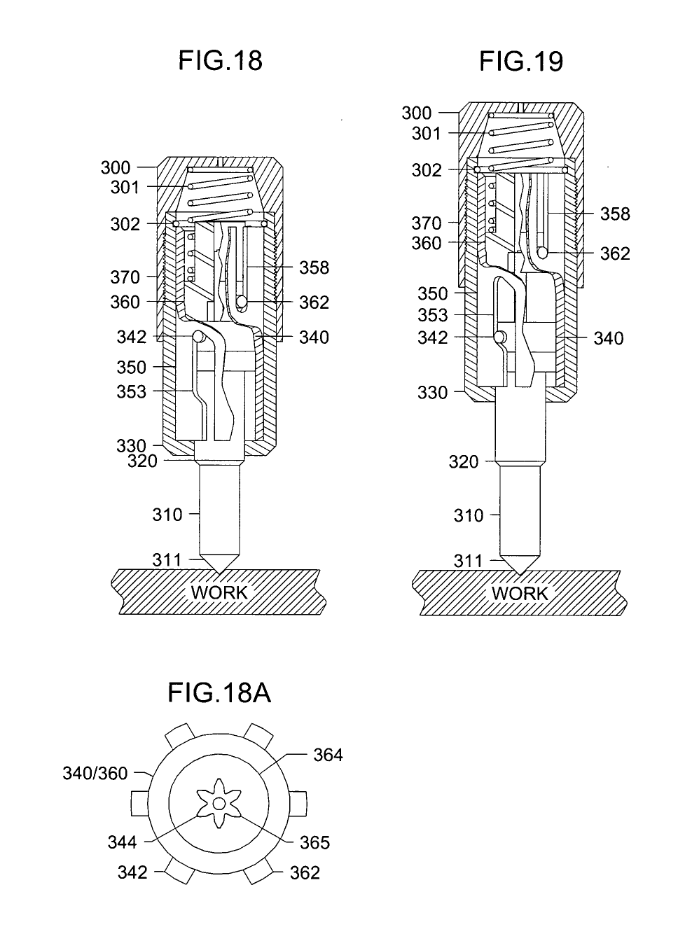

The point where the tops of cam slots 353 have reached cam pins 342 on latch 340 is depicted in FIG. 17. At this point, the relative rotational positions of hammer 360 and latch 340 are still as shown in FIG. 16A. However, since the tops of cam slots 353 in cam sleeve 350 are angled, further depression of the punch body causes the angled portions of cam slots 353 to apply a side force to cam pins 342 on latch 340 which, because latch 340 is confined within cam sleeve 350, causes latch 340 to rotate. When the peaks of cam slots 353 have reached latch cam pins 342, as shown in FIG. 18, latch 340 has rotated enough to align the splines on latch head 344 with the splines in hammer bore 365 as shown in FIG. 18A. At this point, hammer 360 becomes free to slide around latch head 344 and the energy stored in hammer spring 301 when it was compressed forces hammer 360 toward latch 340. The base of hammer 360 impacts the base of latch 340 which, being in direct contact with the anvil, transfers the energy of the impact to anvil 320 which transfers it to punch 310, driving the point of punch head 310 into the work piece.

As the user releases pressure on end cap 370 and housing 330, latch spring 303 pushes end cap 370, housing 330 and cam sleeve 350 away from the work. At the point shown in FIG. 19, the splines on latch head 344 clear the splines in hammer bore 365 and the bottoms of cam slots 353 begin to apply a side force on latch cam pins 342 opposite to the side force applied when the punch body was pressed toward the work piece. This opposite side force rotates latch 340 back to its original position resetting the center punch for its next use.

Although the preceding description of the operation of the center punch refers to the rotation of the latch 340, cam sleeve 350 does not have to be (and, in the embodiment described, is not) restrained from rotating. Thus, depending on relative friction between parts, cam sleeve 350 and hammer 360 could rotate instead of, or in addition to, latch 340. The important motion in the operation of the center punch is the rotation of the latch relative to the hammer. Other possible designs could use a guide slot for latch 350 and a cam slot to rotate hammer 360 or cam slots to rotate both latch 340 and hammer 360 in opposite directions.

The present invention provides a number of advantages over the prior art. When compared to the use of an alignment fixture, optical alignment sight and basic center punch with manually wielded hammer of prior art FIG. 2, the constrained motion of the hammer in the preferred embodiment of the present invention described herein provides a consistent impact orientation that is difficult to achieve by hand. While the maximum achievable accuracy is no better, the range of error is much smaller.

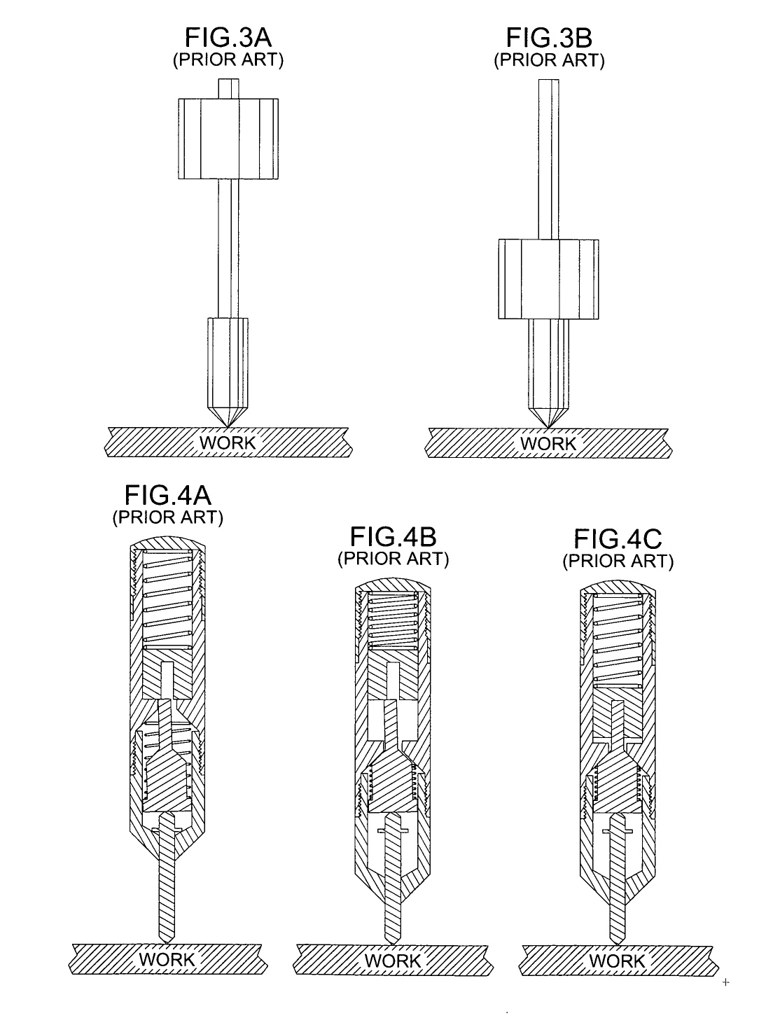

The slide hammer punch in prior art FIGS. 3A and 3B can be made to similar tolerances as the present invention for accuracy, but the present invention provides the ability to work on non horizontal surfaces as shown in FIGS. 23 and 24.

The rocking motion of the mechanism in the prior art center punch shown in FIGS. 4A through 4C requires much more clearance than the rotating mechanism of this invention and, therefore, cannot achieve the same level of consistency.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A center punch comprising:
an end cap;
a hammer that is spring-loaded with a spring against the end cap and positioned along an axis;
a punch head assembly positioned on the axis;
a latch configured to reversibly restrain movement of the hammer along the axis in response to rotational movement of the latch about the axis;
wherein a force applied to the end cap causes the spring to compress,
in response to compression of the spring, the latch rotates about the axis in a first direction and releases the hammer, and
in response to the hammer being released, the spring becomes uncompressed, causing the hammer to move along the axis to strike the punch head assembly.

2. The center punch of claim 1, wherein in response to the hammer having moved along the axis, the latch rotates in a second direction and restrains the hammer.

3. The center punch of claim 1, further comprising:
a cam sleeve having a first cam surface; and
a cam pin attached to the latch,
wherein compression of the spring causes the cam pin to engage the first cam surface, and
the cam pin's engaging the first cam surface causes the latch to rotate in the first direction.

4. The center punch of claim 3, wherein the cam sleeve includes a second cam surface,
movement of the hammer along the axis causes the cam pin to engage the second cam surface, and
the cam pin's engaging the second cam surface causes the latch to rotate in the second direction.

5. The center punch of claim 3, wherein the cam sleeve includes a groove,
the hammer includes a pin that is positioned within the groove, and
the pin's placement within the groove prevents the hammer from rotating about the axis.

6. The center punch of claim 1, wherein the latch includes a shaft with shaft splines,
the hammer includes a bore with bore splines,
the shaft is positioned to fit within the bore,
rotation of the latch in the first direction causes the shaft splines to rotate into alignment with the bore splines,
rotation of the latch in the second direction causes the shaft splines to rotate out of alignment with the bore splines.

7. The center punch of claim 1, wherein the punch head assembly includes a punch head and an anvil, and
the punch head is attached to the anvil.

8. The center punch of claim 1, further comprising:
an alignment fixture including a bore and adapted to hold a fixed location with respect to a work surface
wherein the punch head assembly is positioned within the bore of the alignment fixture so as to hold the punch head in a stationary position on the work surface.

9. The center punch of claim 1, wherein the alignment fixture includes a flat surface adapted to engage a flat work surface.

10. The center punch of claim 1, wherein the alignment fixture includes a concave surface adapted to engage a work surface that is not flat.

11. The center punch of claim 10, wherein the concave surface is adapted to engage a curved work surface.
